(19) United States
(12) Patent Application Publication
(10) Pub. No.: US 2006/0203415 A1
(43) Pub. Date: Sep. 14, 2006

(54) Hole punch having a detached magnetic base

(76) Inventor: John J. Sinisi, Warminster, PA (US)

Correspondence Address: GREGORY J. GORE, 70 WEST OAKLAND AVENUE, SUITE 316, DOYLESTOWN, PA, 18901, US

(21) Appl. No.: 11/074,771

(22) Filed: Mar. 9, 2005

(51) Int. Cl. H01H 47/00

(52) U.S. Cl. 361/160

(57) ABSTRACT

A hole punch with a detached base includes a base supporting an anvil with a first magnetic element, and a punch assembly with a plunger extendable from the framework of the punch assembly. The punch assembly supports a second magnetic element positioned for magnetic coupling to the base to align the anvil with the plunger. The magnetic coupling feature eliminates throat depth limitations caused by the framework of mechanically coupled hole punches of the prior art and allows for hole placement at any desired location on any size of sheet.

### FIELD OF THE INVENTION

The present invention relates generally to hole punchers for creating holes in one or more sheets of paper, or the like, and in particular to a hand-operated hole punch having a detached base.

### BACKGROUND OF THE INVENTION

Hole punches for creating holes in sheets of paper and other similar materials are common in corporate, institutional, and educational environments. Manually operated and electrically powered hole punches are well known and in widespread use. These hole punches have an anvil-supporting base and a punch-driving assembly structurally coupled to the base. The punch assembly includes a spring-loaded plunger with a cutting edge on its impact end. A U-shaped frame holds the punch assembly to a rigidly attached base which includes an apertured anvil for receiving the cutting end of the plunger after it has penetrated the sheets of material. An aperture on the anvil assembly closely receives the plunger cutting edge around its periphery to provide the shearing action required for cutting holes with smooth edges.

These conventional hole punches which have a structurally coupled base and punch assembly all share a common disadvantage in that they define a throat between the arms of a U-shaped frame that has a fixed depth. The throat depth limits the distance from the edge of the sheet at which a hole may be punched. In other words, because of the fixed attachment of the base and the punching assembly, the anvil and punch assembly can only reach inwardly a limited distance from the edge of the sheet, i.e. the point at which the edge of the sheet reaches the innermost portion of the throat where the framework of the base meets the framework of the punch assembly.

This limitation is undesirable in some punching situations where there is a desire to produce holes in the center of a wide sheet of paper or similar material used in large scale projects, e.g. on poster board, student art displays, corporate or promotional displays, etc. The use of large size sheets prohibits punching at certain locations interior to the edges of the sheets using conventional hole punches and limits punching to portions of the sheets near the edges.

There is therefore a need in the art for a hole puncher capable of punching holes into sheets at any desired location including interior locations of relatively large scale sheets.

### SUMMARY OF THE INVENTION

The present invention provides a hole punch having a punch assembly and a detached anvil-supporting base that are magnetically coupleable. The magnetic coupling feature eliminates throat depth limitations caused by the framework of mechanically coupled hole punches of the prior art and allows for hole placement at any desired location on any size of sheet. Additionally, the punching assembly may be used apart from the anvil-supporting base to produce holes in materials where the nature of the material does not require a punch-receiving anvil on its opposite side. In accordance with the present invention, a hole punch with a detached base includes a base supporting an anvil with a first magnetic element, and a punch assembly with a plunger extendable from the framework of the punch assembly. The punch assembly supports a second magnetic element positioned for magnetic coupling to the base to align the anvil with the plunger.

More specifically, the applicant has devised a hole punch with a detached base comprising a base supporting an anvil and a first magnetic element and a punch assembly structurally independent of the base including means for extending and retracting a plunger having a cutting edge on an impact end thereof. The punch assembly supports a second magnetic element which is positioned on the punch assembly for magnetically coupling the base to the punch assembly and to align the anvil with the cutting edge. A spring member preferably biases the plunger toward a retracted position, the plunger being extendable to a position where the cutting edge of the plunger extends through an aperture in the anvil.

While the present invention will be described with the reference to a specific embodiment, the following descriptive is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the reference numerals throughout the various figures of drawing which follow.

### BRIEF DESCRIPTION OF THE DRAWINGS

FIG. 1a is a top right perspective view of the separated components of the invention detached.

FIG. 1b is a front right bottom perspective view of the punch assembly.

FIG. 2 is a top right front perspective view of the components of the invention in their magnetically coupled condition.

FIG. 3 is a top right front perspective assembly view of the punch assembly.

FIG. 4 is a top right front perspective assembly view of the base component of the invention.

### DESCRIPTION OF THE PREFERRED EMBODIMENT

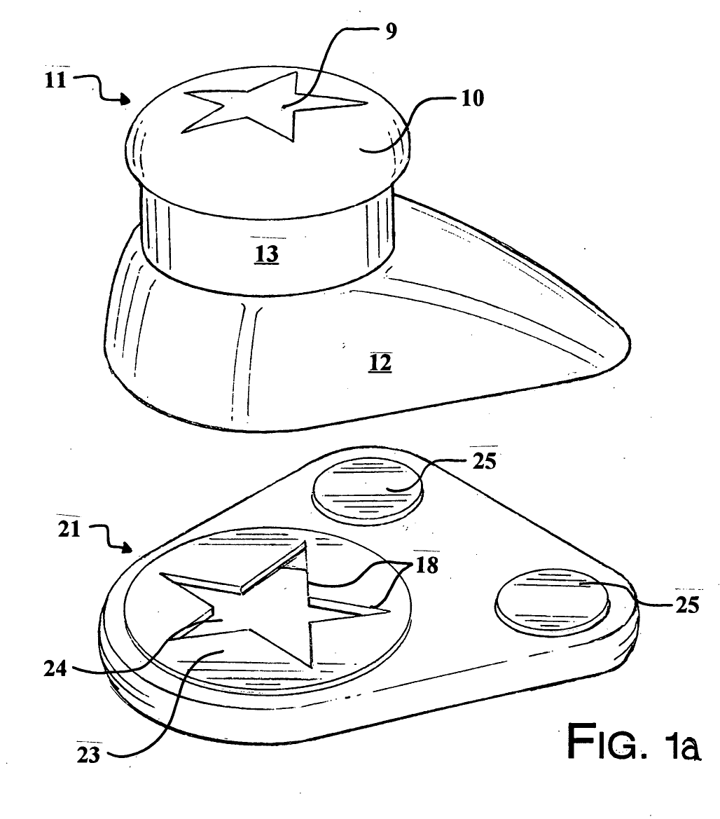

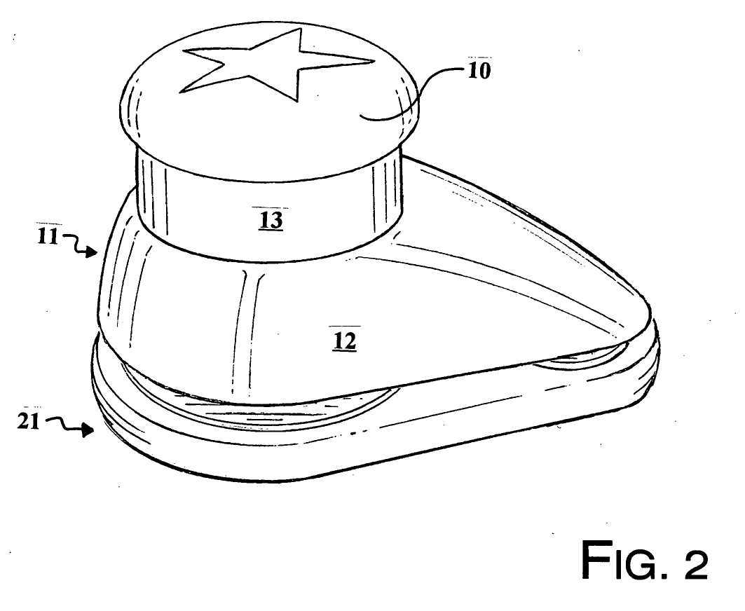

Referring now to FIG. 1a, the present invention includes two major components: a punch assembly 11 and a detached base 21. The punch assembly includes a plunger 13 with a button 10 at a top end thereof and a framework 12 which holds the plunger slidably by means depicted in detail in FIG. 3. Lying directly beneath the punch assembly is detached base 21 which includes magnetic elements 25 and an anvil 23 having an aperture 24 with cutting edges 18 around its periphery. The embodiment shown is a punch assembly which will produce star-shaped holes in sheets placed between the punch assembly and the base. The button 10 preferably includes an indicia 9 which corresponds with the shape of the anvil aperture to indicate the star shape of the punched hole.

Referring now to FIG. 1b, the bottom side of the punch assembly 11 is shown. The framework 12 comprises a cover 15 affixed to a bottom plate 16. The bottom plate 16 of the punch assembly framework holds magnetic elements 17, preferably permanent magnets. The plunger 13 is slidably mounted within the framework and the bottom impact end of the plunger 19 includes raised cutting edges 20 which project downwardly from an end face of the plunger. The shape of the cutting edges 20 corresponds to the dimension and shape of the anvil aperture 24 depicted in FIG. 1a.

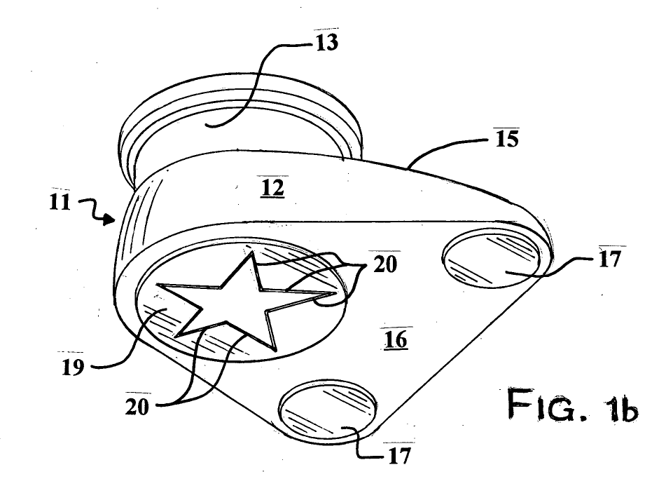

Referring now to FIG. 2, the punch assembly 11 and base 21 components of the hole punch are shown in their magnetically coupled condition with the base aligned with the framework 12 of the punch assembly. Plunger 13 and its cutting edges are in alignment with the anvil such that when the plunger 13 is forcibly moved to its extended position by pushing button 10, the cutting edges on the impact end of the plunger extend through the sheets to be punched (not shown) and through the anvil aperture to provide the shearing action between the plunger and the anvil to produce holes in sheets placed between the punch assembly 11 and the base 21.

Referring now to FIG. 3, various components of the punch assembly are shown. Plunger 13 includes cutting edges 20 which extend downwardly from an endface of the plunger. The plunger 13 is closely received within collar 14 which is rigidly affixed to framework plate 16 to provide the slidable attachment of the plunger to the framework. The plunger 13 includes a flange 28 at the top which acts as a stop between the top of the collar 14 and the underside of cover 15 to restrict its range of movement. Spring means 26 operates between flange 28 and the baseplate 16 to bias the plunger upwardly. Spring 27 of lesser force is positioned between flange 28 and cover 15 to dampen the retraction force of spring 26. Collar 14 is affixed to framework plate 16 by press fit and/or an adhesive. Magnetic elements 17 are also affixed to the framework plate by press fit and/or an adhesive. Button 10 is affixed to the top of the plunger.

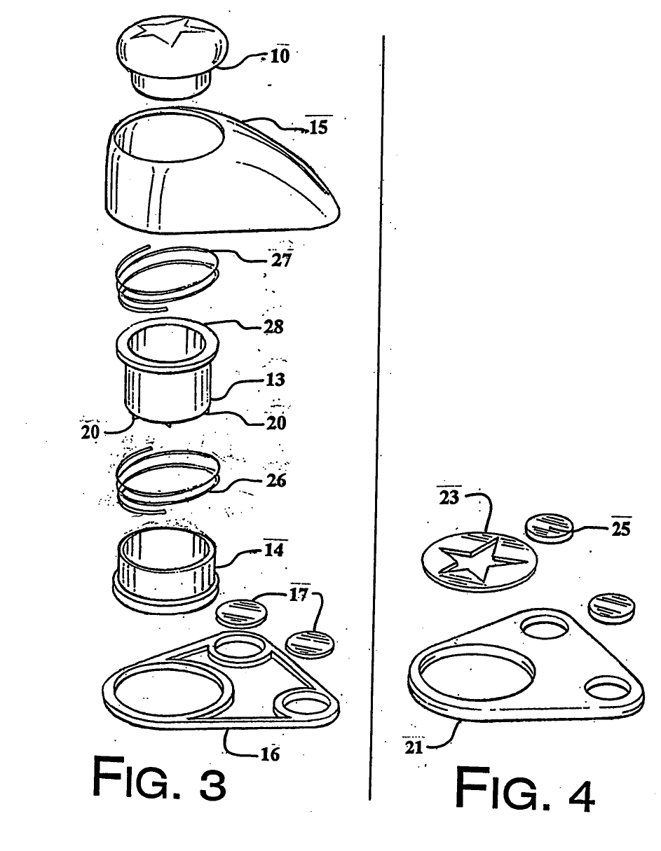

Referring now to FIG. 4, the base 21 includes magnetic elements 25, preferably permanent magnets, affixed by press fit. Anvil 23 is similarly affixed to the base by press fit or an adhesive, or both.

By these mechanical relations described in the foregoing figures of drawing, it will be understood that a hole punch having a magnetically coupled detached base has been devised which will produce holes in one or more sheets located between them. The respective magnetic elements on both components provide alignment means between the two components for holding the detached base against an opposite side of the one or more sheets to be punched regardless of how far from the edge of the sheet the hole is punched. Thus, cutting a hole through one or more sheets may be accomplished by positioning the hole punch's detached base adjacent a first side of one or more sheets, the base supporting an anvil and then positioning a punch assembly adjacent an opposite side of the one or more sheets to magnetically couple the detached base to the punch assembly whereby the anvil is aligned with a cutting edge of the punch assembly. The act of punching is accomplished by cutting a hole through said one or more sheets by forcibly moving an extendable plunger of the punch assembly through said one or more sheets against the base.

It should be understood that there may be other modifications and changes to the present invention that will be obvious to those of skill in the art from the foregoing description, however, the present invention should be limited only by the following claims and their legal equivalents.

What is claimed is:

1. A hole punch with a detached base, comprising:
a base supporting an anvil and a first magnetic element; and
a punch assembly structurally independent of said base and including means for extending and retracting a plunger having a cutting edge on an impact end thereof, said punch assembly supporting a second magnetic element, said second magnetic element being positioned on said punch assembly for magnetically coupling said base to said punch assembly to align said anvil with said cutting edge.

2. The hole punch of claim 1, said punch assembly comprising:
a spring member biasing said plunger toward a retracted position, said plunger being extendable to an extended position where the cutting edge of the plunger extends through an aperture in the anvil.

3. The hole punch of claim 1, wherein said first magnetic element comprises first and second magnets supported on said base in a spaced relationship, and wherein said second magnetic element comprises third and fourth magnets supported on said punch assembly in a corresponding spaced relationship.

4. The hole punch of claim 3, wherein said first and second magnets are positioned to expose opposite magnetic poles for coupling to said punch assembly.

5. The hole punch of claim 1, wherein said first magnetic element comprises a first permanent magnet and said second magnetic element comprises a second permanent magnet.

6. The hole punch of claim 1, wherein each of said first magnetic element and said second magnetic element comprises a plurality of permanent magnets.

7. A hole punch comprising:
a base having an anvil and a first magnetic element;
a framework supporting a punch assembly including a plunger having a cutting edge on an impact end thereof, said plunger being slidably affixed to said framework and movable between retracted and extended positions; and
wherein said anvil includes an aperture for receiving the cutting edge of said plunger when in the extended position.

8. The hole punch of claim 7, wherein said first magnetic element is supported on a cantilevered beam of said base.

9. A method for cutting a hole through one or more sheets, the method comprising the steps of:
positioning a hole punch's detached base adjacent a first side of one or more sheets, the base supporting an anvil;
positioning a punch assembly adjacent an opposite side of the one or more sheets to magnetically couple the detached base to the punch assembly whereby the anvil is aligned with cutting means of the punch assembly; and
punching a hole through said one or more sheets by forcibly moving an extendable plunger of said punch assembly through said one or more sheets against the base.
